(19) United States
(12) Patent Application Publication
(10) Pub. No.: US 2004/0106014 A1
(43) Pub. Date: Jun. 3, 2004

(54) Microwave tunable device having ferroelectric/dielectric BST film

(76) Inventors: Seung Eon Moon, Daejon (KR); Eun-Kyoung Kim, Daejon (KR); Won-Jeong Kim, Daejon (KR); Su-Jae Lee, Daejon (KR); Kwang-Yong Kang, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/690,179

(22) Filed: Oct. 20, 2003

(30) Foreign Application Priority Data
Nov. 29, 2002 (KR) 2002-75291

(51) Int. Cl. B32B 9/00; B32B 19/00

(52) U.S. Cl. 428/697; 428/701; 428/702

(57) ABSTRACT

Provided is a microwave tunable device including a ferroelectric/dielectric (Ba₁₋ₓ,Srₓ)TiO₃ (BST) thin film that can reduce dielectric loss of a ferroelectric/dielectric BST thin film. The microwave tunable device of the present research includes: a substrate; and a ferroelectric/dielectric (Ba₁₋ₓ,Srₓ)TiO₃ (BST) thin film of a (111) direction which is formed on the substrate. The technology of this research embodies a microwave tunable device by using a ferroelectric/dielectric BST thin film grown in the (111) direction to overcome the limitation of conventional technologies and improve the problem of dielectric loss.

### FIELD OF THE INVENTION

The present invention relates to a microwave device; and, more particularly, to a microwave tunable device including a ferroelectric/dielectric (Ba₁₋ₓ,Srₓ)TiO₃ (BST) thin film.

### DESCRIPTION OF RELATED ART

Among dielectric oxide films, a ferroelectric/dielectric (Ba₁₋ₓ,Srₓ)TiO₃ (BST) thin film can be applied to many fields due to its various characteristics, such as a non-volatile memory device using two stable remanent polarizations, a capacitor in a memory device using a large dielectric constant, an uncooled infrared sensor using pyroelectricity, a fine driving device using piezoelectricity, and an optical device using an electro-optic effect.

A microwave tunable device including a ferroelectric/dielectric material utilizes the difference in dielectric constants, which is caused by the change in the fine structure of the ferroelectric/dielectric material when electric field is applied to it. For example, a phase shifter is a core element of a phase array antenna system where the direction of an antenna beam is controlled not mechanically but electrically; a voltage controlled capacitor or a frequency tunable filter that utilizes the change in the dielectric constant of a ferroelectric/dielectric material which is different based on a given electric field; a voltage controlled resonator; an oscillator; and a voltage controlled distributor. In particular, a ferroelectric/dielectric phase shifter has more advantages than other conventional competitive devices. Since the ferroelectric/dielectric material has a large dielectric constant, a smaller and lighter ferroelectric/dielectric phase shifter can be obtained. Also, due to the characteristics of small response time and small leakage current the ferroelectric/dielectric material has, it consumes a small amount of electric power, low production cost and maintains stable microwave transmission characteristics even under the high microwave transfer power.

Prior to the development of a multi-component oxide thin film technology, single crystal or compressed powder ceramic is used to embody a microwave tunable device. However, this technology has problem that it is hard to grow the single crystal layer and that the relatively large dielectric constant makes it hard to design for impedance matching, thus inducing large reflection loss of a transmission wave. These days, a ferroelectric/dielectric thin film is usually used to embody a microwave tunable device. The dielectric constant of the ferroelectric/dielectric thin film used here should be changed by the electric field very much, and the dielectric loss of the ferroelectric/dielectric material should be small. As a material that can satisfy these requirements, (Ba₁₋ₓ,Srₓ)TiO₃ (BST) is used widely.

In the microwave tunable device including a ferroelectric/dielectric BST thin film, the device loss occurs for three reasons, except for the loss generated by the design itself: the loss by electrodes, the loss by radiation, and the loss by a ferroelectric/dielectric material itself. The loss by electrodes can be reduced by making the thickness of the electrode several times thicker than the skin depth of the transmission wave. The loss by radiation can be reduced by performing packaging properly. However, in case of the loss by a ferroelectric/dielectric material itself, there is no way to reduce it by other methods, for example, the above-described method.

Conventionally, a microwave tunable device is formed using a ferroelectric/dielectric BST thin film which is grown in the direction of (001) or (011). Particularly, a microwave tunable device using a BST thin film of the (011) direction has the almost same dielectric loss as the microwave tunable device using a BST thin film of the (001) direction, but it has a much larger change rate of dielectric constant than that.

Basically, there is a limit in reducing the loss of a microwave tunable device which is generated by the dielectric loss of the ferroelectric/dielectric BST thin film. This has been pointed out as a problem when the microwave tunable device using a BST thin film of the (011) direction is compared with other microwave tunable device using a ferroelectric substance or a semiconductor.

### SUMMARY OF THE INVENTION

It is, therefore, an object of the present invention to provide an ultrahigh tunable device that can reduce the dielectric loss of a ferroelectric/dielectric (Ba₁₋ₓ,Srₓ)TiO₃ (BST) thin film.

In accordance with an aspect of the present invention, there is provided a microwave tunable device, including: a substrate; and a ferroelectric/dielectric BST thin film of a (111) direction which is formed on the substrate.

In accordance with another aspect of the present invention, a microwave tunable device is embodied by using a ferroelectric/dielectric BST thin film which is grown in the (111) direction. The problem of loss in a microwave tunable device can be improved this way.

### BRIEF DESCRIPTION OF THE DRAWINGS

The above and other objects and features of the present invention will become apparent from the following description of the preferred embodiments given in conjunction with the accompanying drawings, in which:

FIGS. 1A and 1B are a plane figure and a perspective diagram illustrating an interdigital capacitor used in a tunable filter or a tunable capacitor;

FIG. 2 is a diagram modeling a perovskite scheme which is one of the representative schemes of ferroelectric/dielectric material;

FIG. 3 is a diagram illustrating a crystal face of the (111) direction;

FIG. 4 is a graph showing θ-2θ x-ray diffraction patterns of a ferroelectric/dielectric (Ba₁₋ₓ,Srₓ)TiO₃ (BST) thin film, which is grown by a pulsed laser ablation method at different deposition temperatures;

FIG. 5 is a graph showing θ-2θ x-ray diffraction pattern of a ferroelectric/dielectric BST thin film grown by a pulsed laser deposition method in the directions of (001), (011) and (111); and

FIGS. 6A and 6B are graphs depicting quality factor (Q) and the variation rate of a dielectric constant based on the direct current voltage applied to the interdigital capacitor embodied by using a ferroelectric/dielectric BST thin film.

### DETAILED DESCRIPTION OF THE INVENTION

Other objects and aspects of the invention will become apparent from the following description of the embodiments with reference to the accompanying drawings, which is set forth hereinafter.

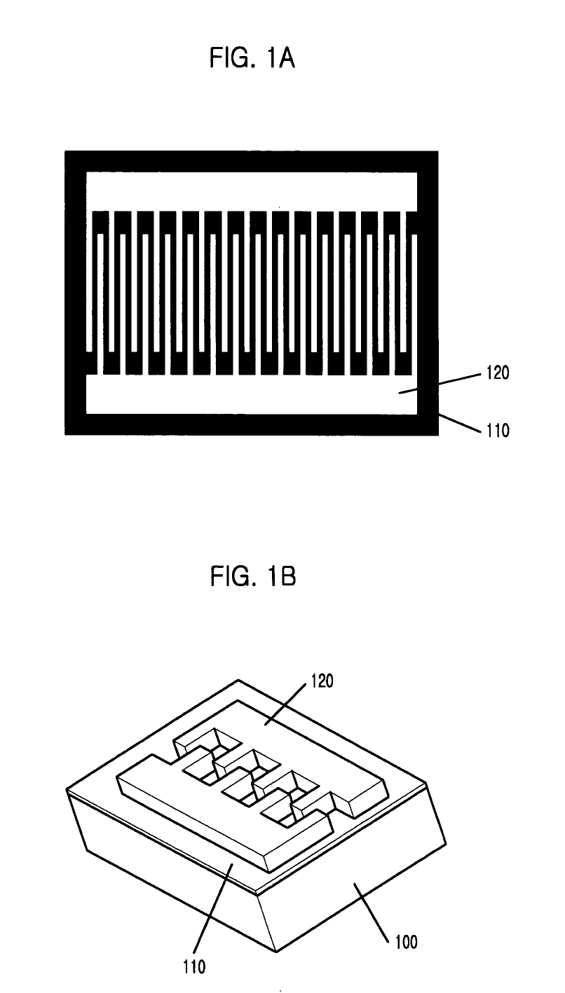

FIGS. 1A and 1B are a plane figure and a perspective diagram illustrating an interdigital capacitor used in a tunable filter or a tunable capacitor. Following is a process for manufacturing a microwave tunable device in accordance with an embodiment of the present invention.

First, a ferroelectric/dielectric (Ba₁₋ₓ,Srₓ)TiO₃ (BST) thin film 110 is grown on a MgO substrate 100. The temperature of the substrate is increased over a predetermined level, and the ferroelectric/dielectric BST thin film 110 is grown. The thickness of the ferroelectric/dielectric BST thin film 110 can be controlled from a couple of nm to several mm according to the usage of the device. Desirably, a pulsed laser ablation is used here to grow the ferroelectric/dielectric BST thin film 110. The pulsed laser ablation is a method depositing a material by concentrating a high-energy laser with reflection and concentration plates, such as KrF, on a target in a chamber and ablating the target material. This method is good for depositing a material including multi-components in the form of a thin film. It has a quicker deposition speed than those of other deposition methods.

Subsequently, a material for forming electrodes is deposited on the ferroelectric/dielectric BST thin film 110, and an electrode pattern 120 is formed by performing photolithography and etching processes. The microwave tunable device embodied through the above processes is operated by applying direct current or alternating current voltage thereto.

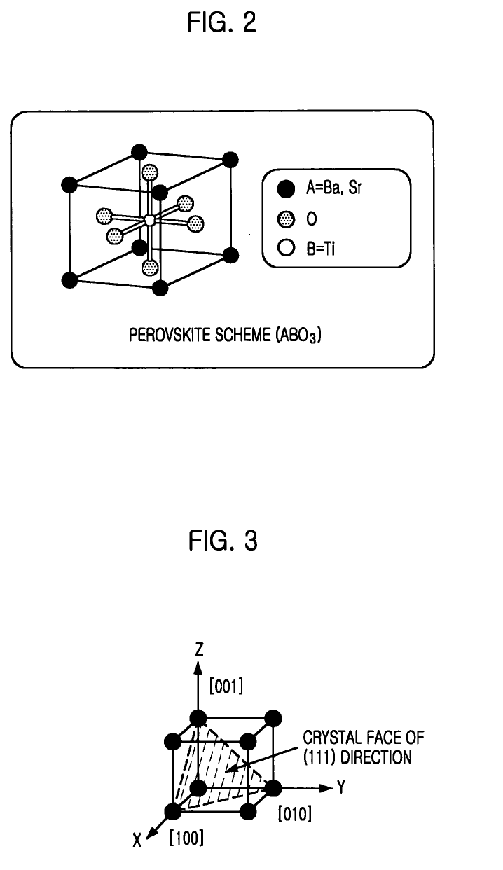

FIG. 2 is a diagram modeling a perovskite scheme which is one of the representative schemes of ferroelectric/dielectric material. In the perovskite scheme, BST has oxygen (O) at the center of the respective faces of the cube, barium (Ba) or strontium (Sr) at the angular points, and titanium (Ti) at the center of the cube.

FIG. 3 is a diagram illustrating a crystal face of the (111) direction.

Meanwhile, the MgO substrate 100 has a structure of NaCl, which is cubical. For this reason, it is popularly used for growing a BST thin film. However, the lattice constants of MgO and BST are 4.212 and 3.965, respectively. Since the difference between the two lattice constants is 6.2%, proper deposition conditions should be satisfied in order to grow the BST thin film 110 on the MgO substrate 100, such as the distance between the substrate and the target, deposition pressure, and deposition temperature.

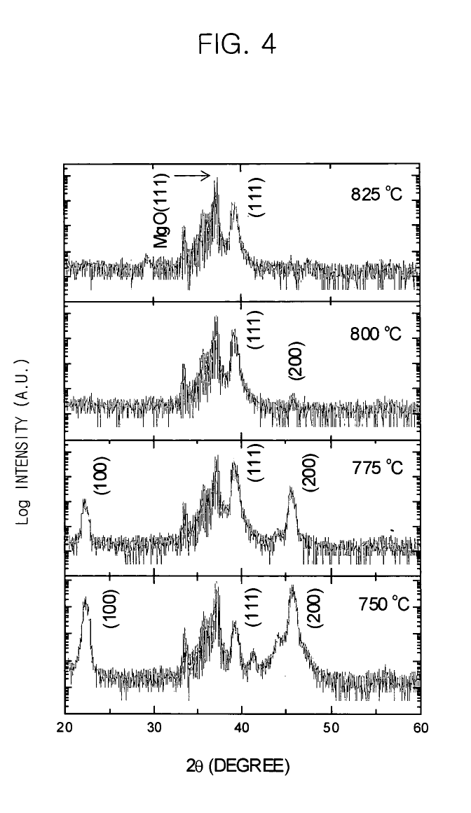

FIG. 4 is a graph showing θ-2θ x-ray diffraction patterns of a ferroelectric/dielectric BST thin film, which is grown in a pulsed laser deposition method based on different deposition temperatures. Since the orientation of the (111) direction shows no considerable change in the deposition pressure when the distance between the target and the substrate is fixed at 5 cm, the deposition pressure is set to be 200 mTorr. When the deposition temperature is 750° C., additional peak appears in the (001) direction. The intensity of (001) peak, however, is lowered as the deposition temperature is raised. When the deposition temperature is 825° C., peaks show up in the (111) direction where there is no peak of the (001) direction.

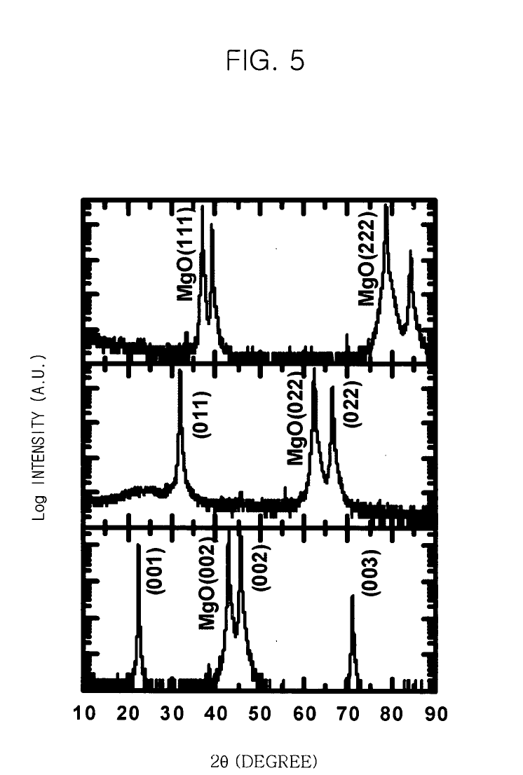

FIG. 5 is a graph showing θ-2θ x-ray diffraction patterns of a ferroelectric/dielectric BST thin film grown by a pulsed laser deposition method in the directions of (001), (011) and (111). FIG. 5 shows that x-ray peaks appear only in the directions of (001), (011) and (111). This signifies that the ferroelectric/dielectric BST thin films of the respective directions are grown to be matched.

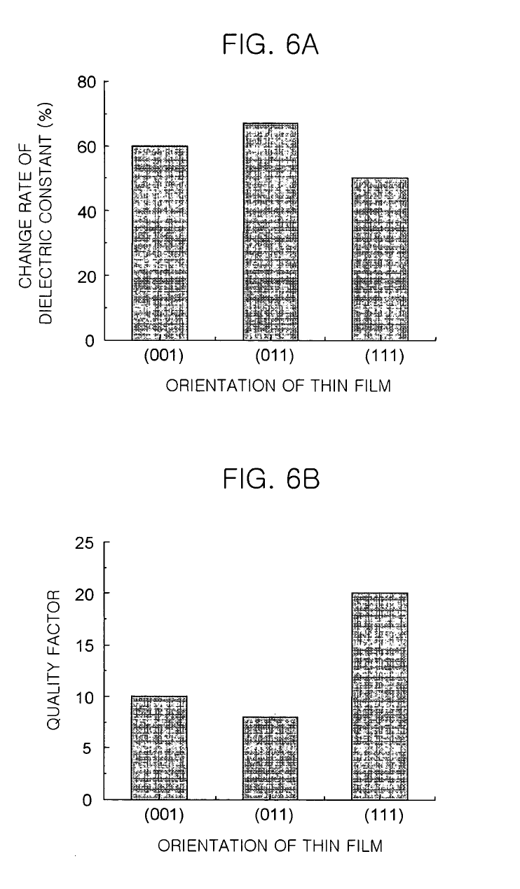

FIGS. 6A and 6B are graphs depicting quality factor (Q) and the change rate of a dielectric constant based on the direct current voltage applied to the interdigital capacitor embodied by using a ferroelectric/dielectric BST thin film. Referring to FIG. 6A, a device including a BST thin film of the (011) direction showed the largest change rate in dielectric constant based on the applied direct current voltage. However, the other device embodied with two BST thin films of the (001) and (111) directions showed more than 50% of a dielectric constant change rate.

Referring to FIG. 6B, since a quality factor conceptualizes an inverse number of dielectric loss, the larger a quality factor is, the less the dielectric loss becomes. Differently from the change rate of dielectric constant, the value of quality factor appeared in a device embodied with a BST thin film of the (111) direction more than twice as large as that of a device embodied with two BST thin films of (110) and (011) direction. In case of a ferroelectric/dielectric thin film, the dielectric loss becomes small generally as the applied voltage is raised. In the case of FIG. 6B, the applied voltage is 0 V.

Usually, the larger the change rate of dielectric constant and the Q value, the better it is. However, experiments report that the two values tend to be in inverse proportion to each other. Characteristics of a device are known by the multiplication of the two values. Therefore, when the values measured in the devices, each embodied based on the orientation of a thin film, are compared, the values are 6, 5 and 10 with respect to the (001), (011) and (111) directions, respectively. In conclusion, a device embodied with a BST thin film of the (111) direction has the largest value.

The BST thin film of the (111) direction showed the excellent characteristics mainly because of the difference in the physical property according to the orientation of the ferroelectric/dielectric BST thin film, that is, the difference in the direction of dipoles that react to the electric field and the direction of the electric filed applied thereto according to the orientation of the ferroelectric/dielectric BST thin film. Besides, there may be other factors, such as oxygen vacancy within the BST thin film, the difference in the thermal expansion rate between the BST thin film and the substrate, strain/stress between the BST thin film and the substrate and the like.

The microwave tunable device including a ferroelectric/dielectric BST thin film of the (111) direction, which is formed in accordance with the present invention, has a property of excellent response due to relatively small dielectric loss of the BST thin film. Since it can reduce the deformation or loss of data by producing small electric wave loss in a phase array antenna system or a satellite communication system and, thus, reduce the amount of amplification when electric wave is discharged from an antenna, the microwave tunable device of the present invention is very advantageous in the aspect of output efficiency of the entire system.

While the present invention has been described with respect to certain preferred embodiments, it will be apparent to those skilled in the art that various changes and modifications may be made without departing from the scope of the invention as defined in the following claims. For example, the embodiment described above shows a case where an MgO substrate is used as a substrate for a microwave tunable device. However, the microwave tunable device can be embodied on another type of substrate. The technology of the present invention can be applied to all microwave tunable devices including a voltage tunable capacitor, a voltage tunable resonator, a voltage tunable filter, a phase shifter, a distributor, an oscillator and the like.

What is claimed is:

1. A microwave tunable device, comprising:
a substrate; and
a ferroelectric/dielectric (Ba₁₋ₓ,Srₓ)TiO₃ (BST) thin film of a (111) direction which is formed on the substrate.

2. The microwave tunable device as recited in claim 1, wherein the ferroelectric/dielectric BST thin film is grown by performing a laser ablation.

3. The microwave tunable device as recited in claim 1, wherein the substrate is an MgO substrate.
